(19) United States
(12) Patent Application Publication
(10) Pub. No.: US 2013/0334125 A1
(43) Pub. Date: Dec. 19, 2013

(54) Laser Welded Spin-On Type Lube Filter

(71) Applicant: MANN+HUMMEL Purolator Filters LLC, Fayetteville, NC (US)

(72) Inventors: Lawrence KARLOVICH, Sanford, NC (US); Randy FRYE, Fayetteville, NC (US)

(21) Appl. No.: 13/919,169

(22) Filed: Jun. 17, 2013

Related U.S. Application Data
(60) Provisional application No. 61/661,164, filed on Jun. 18, 2012.

(51) Int. Cl. B01D 35/30

(52) U.S. Cl. CPC B01D 35/30
USPC 210/443; 228/101; 228/159

(57) ABSTRACT

A circumferentially extending weld, utilized to join the side wall and the end plate of a fluid filter together, is disposed at a terminus of at least one of the side wall and an upstanding flange of an end plate. The circumferentially extending weld may take various forms, and, for example, can be provided at adjoining axially facing ends of the upstanding flange and the side wall, between a terminal end of the side wall and a circumferentially extending inner surface of the upstanding flange, or between a terminal end of the side wall and a circumferentially extending outer surface of the upstanding flange.

The present invention claims priority to U.S. Provisional Application No. 61/661,164, also titled Laser Welded Spin-On Type Lube Filter, filed Jun. 18, 2012, the entire disclosure of which is incorporated herein by reference.

### BACKGROUND OF THE INVENTION

1. Field of the Invention

This invention concerns fluid filters with certain types of connections between outer filter housings and end plates closing off a volume of those housings, as well as to a process for making housings having such connections.

2. Description of Related Art

U.S. Pat. No. 6,384,369 to Stenersen et al. discloses liquid filter constructions including a baffle plate secured to a can by way of laser welding. The entire disclosure of the Stenersen et al. ('369) patent is incorporated herein by reference as non-essential subject matter.

Various other documents concern arrangements that also relate to the subject matter of this application. U.S. Patent Application Publication 2006/0062567 to Reder et al., for example, discloses a filter cartridge having a peripheral wall and a lid that are laser welded together. U.S. Patent Application Publication 2008/0060987 to Goto concerns a filter with case members and a filter medium holding frame with weld portions in various locations. U.S. Patent Application Publication 2010/0084334 to Galifi et al. relates to a filter element having a welded joint between a filter ring body end, a support body end edge, and an enclosure surface.

U.S. Pat. No. 4,719,012 to Groezinger et al., U.S. Pat. No. 4,859,328, also to Groezinger et al., and U.S. Pat. No. 5,647,504 to Gullett et al., U.S. Patent Application Publication 2002/0030007 to Koh, U.S. Patent Application Publication 2002/0139735 to Stenersen et al., U.S. Patent Application Publication 2004/0237488 to Stenersen, U.S. Patent Application Publication 2006/0191840 to Homi, U.S. Patent Application Publication 2009/010554 to Kreiner et al., U.S. Patent Application Publication 2010/0224538 to Nieuwland, and U.S. Patent Application Publication 2010/0108589 to Frye et al., Canadian Patent 1,292,955 to Groezinger et al., Canadian Patent 1,292,956, also to Groezinger et al., German Document 103 58 134 to Wagner, European Patent Document 1,438,998 to Cedzich et al., Chinese Document 101716433 to Thienel et al., International Publication WO 2010/149728 to Thienel, and International Publication 2011/088869 to Galifi et al. may also be of interest.

### SUMMARY OF THE INVENTION

In one preferred arrangement, an outer case for a fluid filter includes a circumferentially extending side wall and an end wall closing off one axial end of a volume delimited by the side wall. The other axial end of the volume is closed off by a plate that includes openings for supply of fluid to and discharge of fluid from the volume and that defines an upstanding flange at least partially receivable within said side wall. A circumferentially extending weld, utilized to join the side wall and the end plate together, is disposed at a terminus of at least one of the side wall and the upstanding flange. The circumferentially extending weld may take various forms, and, for example, can be provided at adjoining axially facing ends of the upstanding flange and the side wall, between a terminal end of the side wall and a circumferentially extending inner surface of the upstanding flange, or between a terminal end of the side wall and a circumferentially extending outer surface of the upstanding flange.

In the process of making an outer case, after joining the side wall and the end plate together with the circumferentially extending weld, a radially outer part of the side wall and the end plate to produce a final side wall to end plate connection.

### BRIEF DESCRIPTION OF THE DRAWINGS

FIG. 1 is a side view, in section, of an outer case for a fluid filter according to one embodiment of the invention.

FIG. 2 is a perspective view of the arrangement illustrated in FIG. 1.

FIG. 3 is an end view of a plate fixed to an open end of the outer case shown in FIG. 1.

FIG. 4 is an enlarged view of a part of FIG. 1 used in a discussion, to follow, of several ways of securing the outer case side wall and the plate together.

FIGS. 5 and 6 illustrate one way of interconnecting modified versions of an outer case side wall and a plate according to the invention.

Each of FIGS. 7-10 shows other alternative arrangements usable to interconnect an outer case side wall and a plate according to the invention.

### DETAILED DESCRIPTION OF THE INVENTION

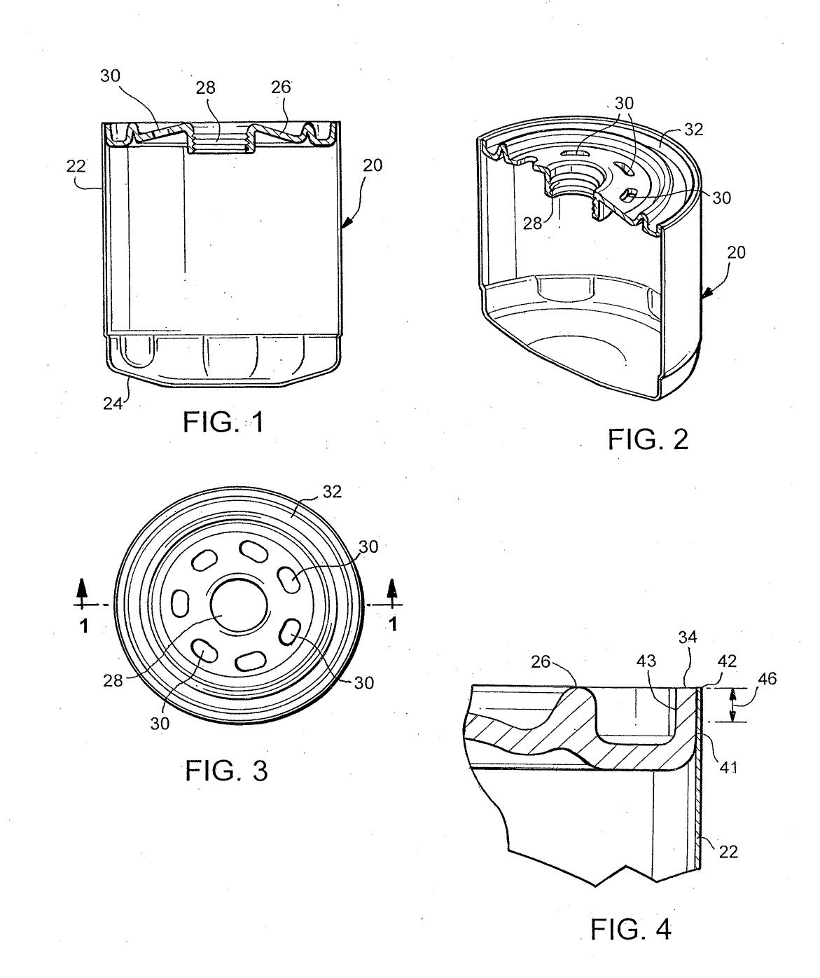

The sectional view provided by FIG. 1 illustrates an outer case 20 composed of an approximately cylindrical side wall 22, an end wall 24, and a stamped or otherwise formed plate 26 fixed to an open end of the outer case 20 that is axially opposed to the end wall 24. It will be recognized that the fluid filter arrangement forming the subject matter of this invention shares various characteristics with the arrangement forming the subject matter of commonly assigned U.S. Patent Application Publication 2010/0288688 to Bryson et al., the entire disclosure of which is incorporated herein by reference as non-essential subject matter. As in the Bryson et al. application, the term “fluid” used here is intended to include oil as well as other liquids, fluids, fluid suspensions, or even air.

The stamped plate 26 defines an annular wall provided with an oil filter discharge opening 28 as well as holes, slots, perforations, or other such openings 30 circumferentially surrounding the discharge opening. The discharge opening 28 is typically threaded for connection to a correspondingly threaded fitting attached to or forming part of a vehicle engine, so that oil leaving the fluid filter outer case 20 through the discharge opening 28 enters the engine oil circulating system. One or more filter cartridges (not shown) are received within and retained by the plate 26 in the outer case 20 when the filter has been fully assembled and/or is in use.

FIG. 2 is a perspective view of the arrangement illustrated in FIG. 1, and more clearly illustrates the arrangement of the discharge opening 28 and the openings 30 in the plate 26 by which fluid to be filtered is admitted into the case 20. The end view of the plate provided by FIG. 3 also shows these features. A retention groove 32 at an outer circumferential location of the plate 26, within which a seal gasket is to be seated, is also identified in both FIG. 2 and FIG. 3.

Several ways of securing the side wall 22 of the outer case to the plate 26 will now be described with particular reference to FIG. 4. As illustrated in FIG. 4, an upstanding circumferentially extending, radially outer flange 34, forming a side wall of the retention groove 32, is connected at its outer circumferential surface by way of a circumferentially extending weld 41 to an area of the inner surface of the cylindrical side wall 22. The weld 41 is displaced by a distance 46 from the axial end of the side wall 22, and is similar in location and type to the weld utilized to interconnect the can and baffle plate of the arrangement forming the subject matter of U.S. Pat. No. 6,384,369 to Stenersen et al. mentioned above.

According to the present invention, welds at certain alternative locations are contemplated in order to facilitate different manufacturing processes. Referring again to FIG. 4, a weld may, for example, be provided at adjoining axially facing terminal ends of the upstanding flange 34 and the side wall 22, at a location 42. Alternatively, if it is desired to fold an end section of the side wall 22 around the axially facing end of the flange 34, a weld may be provided between the terminal end of the side wall 22 and a circumferentially facing inner surface of the upstanding flange 34, at a location 43. Of the locations 42 and 43, the location 42 is considered preferable.

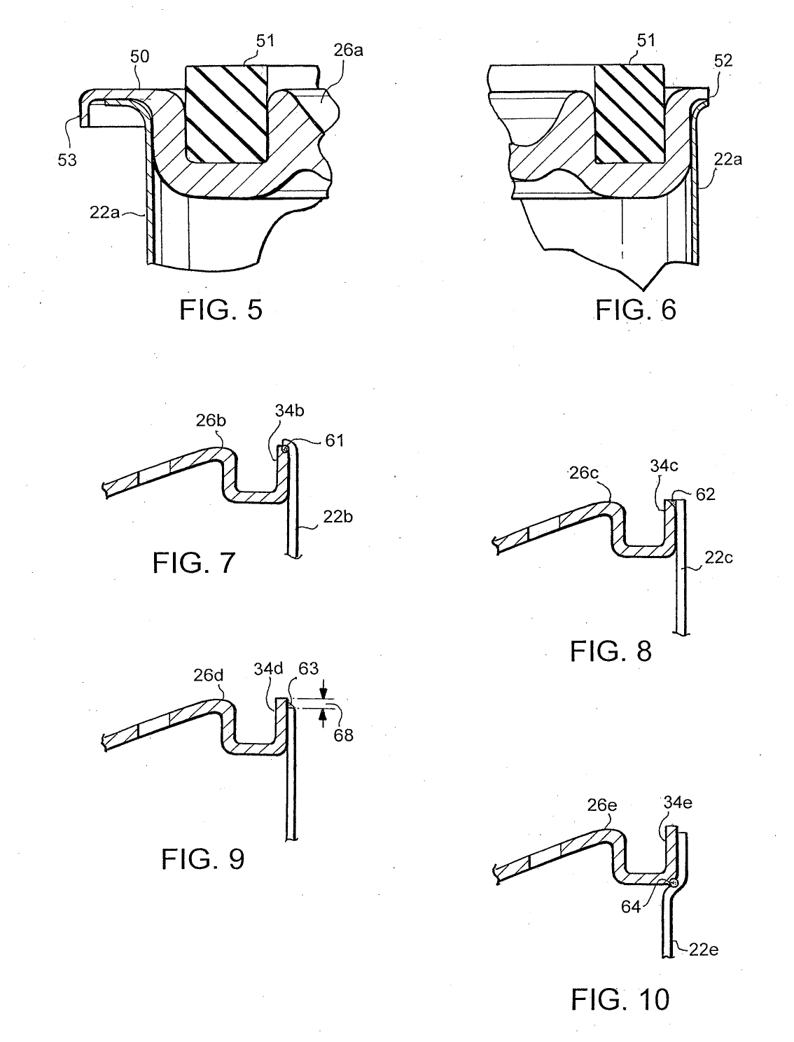

FIGS. 5 and 6 illustrate a manner of producing a weld usable to interconnect modified versions of an outer case side wall and a plate. The plate 26a shown in FIG. 5 may be seen to include a radially outwardly extending flange 50 having a downwardly protruding lip 53. FIGS. 5 and 6 also show a seal gasket 51 seated in position on the plate 26a. The end section of the side wall 22a is deformed radially outwardly so as to roughly correspond to the contour defined by the facing surface of the flange 50, and this flange end section and facing surface of the flange 50 are welded together. Lip 53, a part of the flange 50, and a terminal portion of the side wall 22a are then cut away, ground away, or otherwise removed to leave the structure illustrated in FIG. 6 with a circumferentially extending weld at a location 52.

Each of FIGS. 7-10 shows other alternative arrangements usable to interconnect an outer case side wall and a plate according to the invention. FIG. 7, for example, illustrates a side wall 22b as including an end section that is rolled or otherwise deformed radially inwardly so as to overlie the terminal end of an upstanding circumferentially extending, radially outer flange 34b. The weld used to interconnect the plate 26b and the deformed side wall end section is disposed on the axial facing end of the flange 34b and slightly displaced from the terminus of the deformed side wall end section, at a location 61. FIG. 8 shows a side wall 22c as including an end section that terminates without deformation, but extends slightly beyond an outer surface of the upstanding circumferentially extending, radially outer flange 34c. The axial face of the flange 34c may be beveled as shown. The weld at a location 62 used to interconnect the plate 26c and the side wall end section is disposed on the axial facing end of the flange 34c and preferably is approximately coextensive with the terminus of the side wall end section. FIG. 9 shows an arrangement that is similar to that shown in FIG. 8 but in which the terminus of the side wall end section is displaced by a distance 68 from the axial facing end of the flange 34d so that a weld at a location 63, used to interconnect the plate 26d and the side wall end section, is disposed at the terminus of the side wall end section but on the circumferential outer surface of the upstanding circumferentially extending, radially outer flange 34d. Finally, FIG. 10 illustrates a side wall 22e as including a section displaced from the side wall terminus that is rolled or otherwise deformed radially so as to follow the contour of the underside of the plate 26e. The weld used to interconnect the plate 26e and the deformed side wall section is disposed, on matching curved or otherwise contoured surfaces, at the junction between the end flange 34e with the remainder of the plate 26e and the corresponding interior surface of the side wall 22e, at a location 64.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An outer case for a fluid filter comprising:
a circumferentially extending side wall and an end wall closing off one axial end of a volume delimited by the side wall,
a plate closing off another axial end of the volume, including openings for supply of fluid to and discharge of fluid from the volume, and defining an upstanding flange at least partially receivable within said side wall, and
a circumferentially extending weld joining the side wall and the plate together, said circumferentially extending weld disposed at a terminus of at least one of the side wall and the upstanding flange.

2. The outer case of claim 1, wherein the circumferentially extending weld is provided at adjoining axially facing ends of the upstanding flange and the side wall.

3. The outer case of claim 1, wherein the circumferentially extending weld is provided between a terminal end of the side wall and a circumferentially extending inner surface of the upstanding flange.

4. The outer case of claim 1, wherein the circumferentially extending weld is provided between a terminal end of the side wall and a circumferentially extending outer surface of the upstanding flange.

5. The outer case of claim 1, wherein the circumferentially extending weld is disposed at adjoining radially facing terminal ends of the upstanding flange and the side wall.

6. The outer case of claim 5, wherein the adjoining ends face radially outward with respect to the plate.

7. The outer case of claim 1, wherein the terminus is a terminal end of the side wall that faces radially inwardly with respect to the plate.

8. The outer case of claim 1, wherein the terminus is a beveled terminal end of the upstanding flange.

9. The outer case of claim 1, wherein the terminus is a corner ⱼunction between the upstanding flange and a remainder of the plate.

10. A process of making an outer case for a fluid filter comprising:
providing a circumferentially extending side wall and an end wall closing off one axial end of a volume delimited by the side wall,
closing off another axial end of the volume with a plate, including openings for supply of fluid to and discharge of fluid from the volume and defining an upstanding flange at least partially receivable within said side wall, and
joining the side wall and the plate together with a circumferentially extending weld disposed at a terminus of at least one of the side wall and the upstanding flange.

11. The process of claim 10, further comprising removing a radially outer part of the side wall and the end plate after joining the side wall and the end plate together with the circumferentially extending weld.

12. A fluid filter arrangement including an outer case comprising:
a circumferentially extending side wall and an end wall closing off one axial end of a volume delimited by the side wall,
a plate closing off another axial end of the volume, including openings for supply of fluid to and discharge of fluid from the volume, and defining an upstanding flange at least partially receivable within said side wall, and
a circumferentially extending weld joining the side wall and the plate together, said circumferentially extending weld disposed at a terminus of at least one of the side wall and the upstanding flange.

13. The fluid filter of claim 12, wherein the circumferentially extending weld is provided at adjoining axially facing ends of the upstanding flange and the side wall.

14. The fluid filter of claim 12, wherein the circumferentially extending weld is provided between a terminal end of the side wall and a circumferentially extending inner surface of the upstanding flange.

15. The fluid filter of claim 12, wherein the circumferentially extending weld is provided between a terminal end of the side wall and a circumferentially extending outer surface of the upstanding flange.

16. The fluid filter of claim 12, wherein the circumferentially extending weld is disposed at adjoining radially facing terminal ends of the upstanding flange and the side wall.

17. The fluid filter of claim 16, wherein the adjoining ends face radially outward with respect to the plate.

18. The fluid filter of claim 12, wherein the terminus is a terminal end of the side wall that faces radially inwardly with respect to the plate.

19. The fluid filter of claim 12, wherein the terminus is a beveled terminal end of the upstanding flange.

20. The fluid filter of claim 12, wherein the terminus is a corner junction between the upstanding flange and a remainder of the plate.
